(19) United States
(12) Patent Application Publication
(10) Pub. No.: US 2005/0135624 A1
(43) Pub. Date: Jun. 23, 2005

(54) System and method for pre-authentication across wireless local area networks (WLANS)

(76) Inventors: Ya-Hsang Tsai, Taipei City (TW); Yu-Ren Huang, Banqiao City (TW); Chien-Chao Tseng, Hsinchu City (TW); Chih-Hao Hu, Taipei City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/861,092

(22) Filed: Jun. 4, 2004

(30) Foreign Application Priority Data
Dec. 19, 2003 (TW) 92136128

(51) Int. Cl. H04K 1/00

(52) U.S. Cl. 380/270

(57) ABSTRACT

A system and method for pre-authentication across wireless local area networks (WLANs). A first access point (AP) receives next handoff authentication information from a mobile device during authentication of the mobile device with the first access point. An authentication server receives the next handoff authentication information, acquires an authentication seed value and calculates a first authentication value using the authentication seed value during a data communication session between the mobile device and the first AP. A second AP receives the first authentication value and the authentication seed value during the data communication session. The second AP receives a connection request message and transmits the authentication seed value to the mobile device when the mobile device hands off the data communication session from the first AP to the second AP. The second AP authenticates the mobile device if a second authentication value from the mobile device corresponds to the first authentication value.

### BACKGROUND OF THE INVENTION

1. Field of the Invention

The present invention relates to wireless LAN authentication technology; and particularly to a method and system for subscriber identity module (SIM) based pre-authentication across wireless LANs.

2. Description of the Related Art

Recently, Subscriber Identity Module (SIM) information has been extensively utilized for authentication, authorization and accounting in wireless telephony networks. A Home Location Register (HLR) stores permanent data about subscribers, including service profiles, location information, and activity status. An Authentication Center (AUC) provides authentication and encryption parameters that verify a mobile station identity and ensure the confidentiality of each call. The subscriber information on the SIM card is transmitted to the HLR via MAP/SS7 protocol for authentication, authorization and accounting.

FIG. 1 is a conventional schematic diagram of IEEE 802.1×wireless LAN authentication. When a mobile station 11 associates with an access point (AP) 12, four communication phases, probe request/response 111, authentication request/response 112, association request/response 113 and Extensible Authentication Protocol over LAN (EAPOL)/Extensible Authentication Protocol (EAP) authentication 114 are undergone to authenticate the association. The protocol is extensible since any authentication mechanism can be encapsulated between the request and response message. The preceding three communication phases were introduced by IEEE 802.11. In addition, IEEE 802.1×employs the following EAP allowing for end-to-end mutual authentication between the mobile station 11 and an authentication server. When the 802.1×entity in the AP 12 is informed that the mobile station 11 has been successfully authenticated, the AP 12 begins forwarding data packets to/from the mobile station 11. EAP defines four basic message types, EAP Request, EAP Response, EAP Success and EAP Failure. Details of the communication are further described in the following.

The mobile station 11 issues a probe request when a mobile station roams into a wireless LAN (WLAN) and detects a beacon broadcast from the AP 12. After receiving a probe response from the AP 12, the mobile station 11 provides a password to the AP 12 for authentication. When the authentication is granted, a link layer association is established between the mobile station 11 and the AP 12. Subsequently, the mobile station 11 must be authenticated by an Authentication, Authorization, and Accounting (AAA) server 14 to acquire appropriate permissions. The AAA server 14 sends an EAP Request message as a challenge to the mobile station 11. The mobile station 11 replies to this message with an EAP Response message. The mobile station 11 is notified via an EAP Success or EAP Failure message.

Typically, the AAA server may be located far from the mobile station, resulting in excessive time for transmission of authentication messages. Additionally, the data communication may break down when the mobile station 11 hands off to another AP with excessive transmission time.

In view of the described limitations, a need exists for a system and method providing an efficient authentication mechanism across WLANs.

### SUMMARY OF THE INVENTION

It is therefore an object of the present invention to provide a system and method of subscriber identity module (SIM) based pre-authentication to perform complicated authentication procedures during a mobile device associates with an AP.

According to the object of the present invention, the system and method is employed in a wireless environment having multiple adjacent access points (APs), and an authentication, authorization and accounting (AAA) server.

First, a mobile device transmits next handoff authentication information, preferably including an “AT_NEXT_NOUNCE_MT” value, to the AAA server during an initiate or handoff authentication communication procedure. The next handoff authentication information is provided for potential handoff authentication. Both the mobile device and a home location register with an authentication center (HLR/Auc) storing a pair comprising an international mobile subscriber identity (IMSI) and a subscriber authentication key (Ki). The IMSI and Ki are unique and correspond to the mobile device.

Next, the AAA server asks the HLR/Auc to acquire authentication seed information. The authentication seed information corresponding to the IMSI, preferably includes at least one authentication triplet, individually, including a random number (RAND), a signature response (SRES) value and a cipher key (Kc). The AAA server calculates a first authentication value, the first authentication value is provided to the mobile device for the AAA server authentication. The first authentication value preferably includes a first “AT_MAC” value calculated by the “HMAC-SHA1-128” algorithm utilizing both the AT_NEXT_NOUCE_MT value and the Kc value as input parameters. The AAA server additionally calculates a second authentication value, the second authentication value is provided to neighboring APs for a handoff authentication of the mobile device. The second authentication value preferably includes a second AT_MAC value, and the second AT_MAC value is preferably calculated as follows. The AAA server calculates the second AT_MAC value using the HMAC-SHA1-128 algorithm utilizing both the SRES value and the Kc value as input parameters. The AAA server issues an. EAP request message with the first authentication value, the second authentication value, and at least one authentication seed value, such as a RAND value, (e.g., EAP-req/SIM/Pre_Challenge) to neighboring APs. The authentication seed value enables the mobile device to generate the second authentication value.

When the mobile device hands off data communication from one AP to another, the newly associated AP issues an EAP request for the mobile device identity (i.e., EAP-request/Identity). The mobile device replies to the request message with an EAP response message preferably having an International Mobile Subscriber Identity (IMSI). The AP issues a proprietary EAP request message with the authentication seed value and the first authentication value (i.e., EAP-request/SIM/Challenge) to the mobile device. After the received authentication value is successfully authenticated, the mobile device calculates a third authentication value. The third authentication value preferably includes a third AT_MAC value, and the third AT_MAC value is preferably calculated as follows. The mobile device calculates at least one SRES value using the A3 algorithm utilizing both the RAND value from the AP and the Ki value as input parameters, at least one Kc value using the A8 algorithm utilizing both the RAND value and the Ki value as input parameters, and the third AT_MAC value using the HMAC-SHA1-128 algorithm utilizing both the resulting SRES values and the resulting Kc value as input parameters. The mobile device replies to the proprietary EAP request message with a proprietary EAP response message having the third authentication value as well as next handoff authentication information preferably including an AT_NEXT_NOUNCE_MT value to the AP. The newly generated AT_NEXT_NOUNCE_MT value is provided for a potential handoff authentication. The AP sends an EAP Success message to the mobile device and sends next handoff authentication information to the AAA server if the third authentication value corresponds to the second authentication value. The remaining pre-authentication mechanisms may be deduced by analogy.

### BRIEF DESCRIPTION OF THE DRAWINGS

The present invention can be more fully understood by reading the subsequent detailed description and examples with references made to the accompanying drawings, wherein:

FIG. 1 is a conventional schematic diagram of IEEE 802.1×wireless LAN authentication;

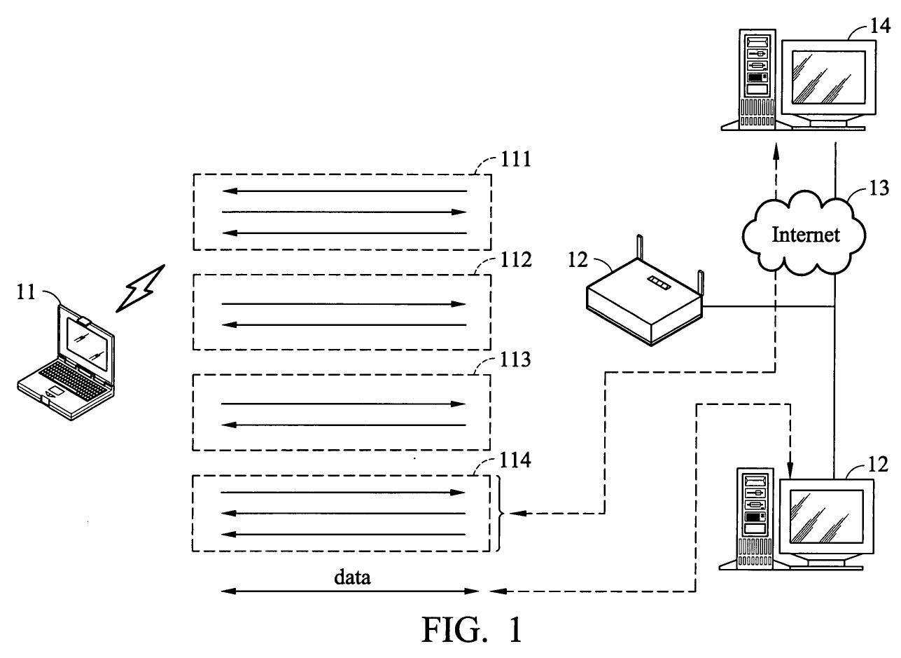

FIG. 2 is an architecture diagram of a subscriber identity module (SIM) based pre-authentication system across wireless local area networks (WLANs) according to the invention;

FIG. 3 is an exemplary communication sequence diagram during an initiate authentication phase according to the invention;

FIG. 4 is an exemplary diagram of a communication sequence during a data communication and handoff authentication phases according to the invention;

FIG. 5 is a flowchart showing a method of SIM based pre-authentication across WLANs according to the invention.

### DETAILED DESCRIPTION OF THE INVENTION

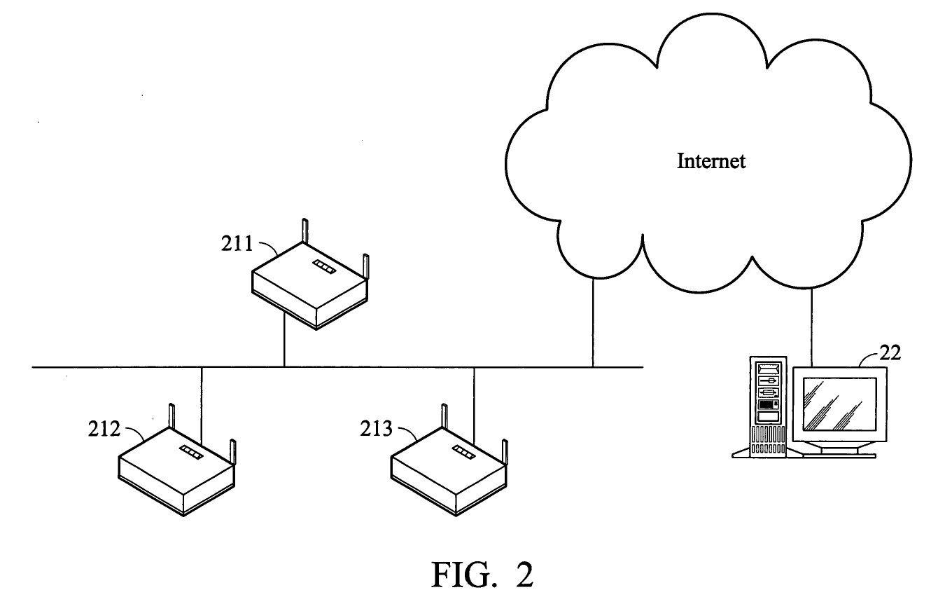

FIG. 2 is an architecture diagram of a subscriber identity module (SIM) based pre-authentication system across wireless local area networks (WLANs) according to the invention. The pre-authentication system 2 preferably includes adjacent access points (APs) 211, 212 and 213, and an Authentication, Authorization and Accounting (AAA) server 22 on the Internet.

In order to accommodate a WLAN and a wireless telephony network, the pre-authentication system 2 may authenticate a mobile device based on SIM. The SIM stored in an IC card as well as an encryption algorithm adopted in the wireless telephony network, provides robust security and is difficult to replicate. According to the invention, the entire pre-authentication process is divided into the following three phases, an initiate authentication, a data communication and a handoff authentication. The initiate authentication occurs when a mobile device initiates a data communication session with the WLAN through the AP 212, the data communication between the mobile device and the AP is performed after the mobile device is authenticated, and the handoff authentication occurs when the mobile device hands off the data communication from the AP 212 to one of the other APs, such as 211 and 213.

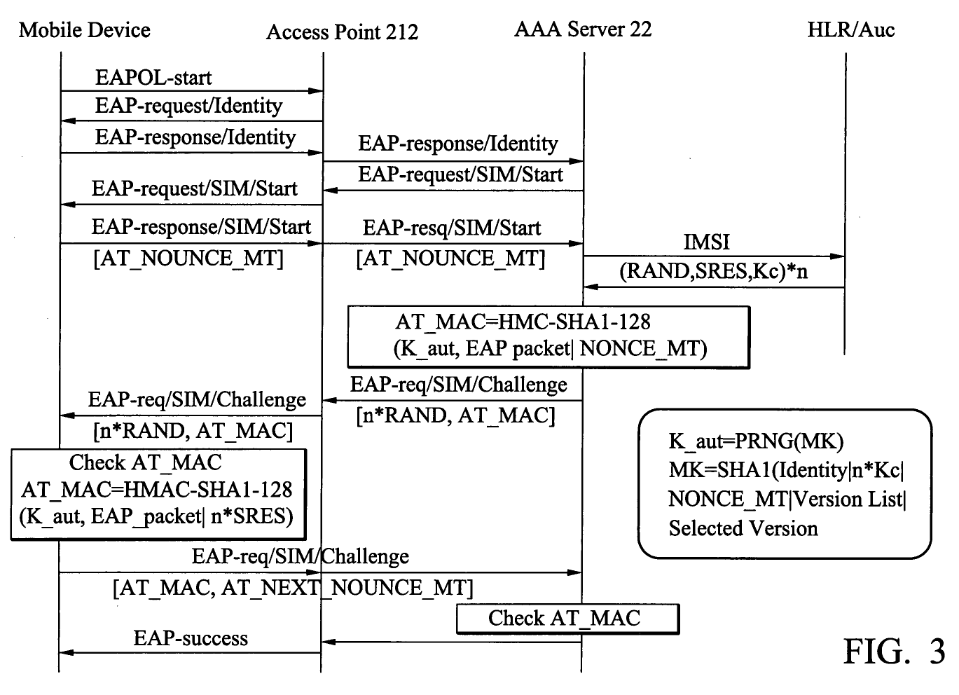

FIG. 3 is an exemplary communication sequence diagram during the initiate authentication phase according to the invention. Both the mobile device and a home location register with an authentication center (HLR/Auc) store a pair of an international mobile subscriber identity (IMSI) and a subscriber authentication key (Ki). The IMSI and Ki are unique, and correspond to a mobile device. In the initiate authentication phase, the mobile device issues an Extensible Authentication Protocol over LAN (EAPOL) start message. An Extensible Authentication Protocol (EAP) request message (i.e., EAP-request/Identity) is sent to the mobile device for a mobile device identity when the access point 212 receives the EAPOL start message. The mobile device issues an EAP response message with the International Mobile Subscriber Identity (IMSI) (i.e., EAP-response/Identity) to the AP 212, and the AP 212 then transmits the response message to the AAA server 22.

The AAA server 22 issues an EAP request message (i.e., EAP-request/SIM/Start) for the EAP-SIM authentication procedure to the mobile device via the AP 212 after receiving the mobile device identity. The mobile device replies to the request message with an EAP response message having initiate authentication information preferably including an “AT_NOUNCE_MT” value (i.e., EAP-response/SIM/Start[AT_NOUNCE_MT]). The initiate authentication information is preferably a random number. The AAA server 22 asks the HLR/Auc to acquire authentication seed information. The authentication seed information corresponding to the IMSI, preferably includes at least one triplet individually comprising a random number (RAND), a signature response (SRES) value and a cipher key (Kc). The RAND value is generated by the Auc, and the SRES value is generated using the A3 algorithm utilizing both the RAND value and the Ki value corresponding to the mobile device as input parameters; and the Kc is generated using the A8 algorithm utilizing both the RAND value and the Ki value as input parameters.

The AAA server 22 calculates a first authentication value, the first authentication value is provided to the mobile device for AAA server authentication. The first authentication value preferably includes a first “AT_MAC” value calculated by the “HMAC-SHA1-128” algorithm utilizing the AT_NEXT_NOUCE_MT value and the multiple Kc values as input parameters. The AAA server 22 sends an EAP request message with the first authentication value and at least one authentication seed value, such as a RAND value, (i.e., EAP-request/SIM/Challenge) to the mobile device via the AP 212. After the first authentication value is successfully authenticated, the mobile device calculates a second authentication value. The second authentication value preferably includes a second AT_MAC value, and the second AT_MAC value is preferably calculated as follows. The mobile device calculates a SRES value using the A3 algorithm utilizing both the RAND value from the AAA server 22 and the Ki value as input parameters, a Kc value using the A8 algorithm utilizing the RAND value and the Ki value as input parameters, and the second AT_MAC value using the HMAC-SHA1-128 algorithm utilizing the resulting SRES values and the resulting Kc value as input parameters. The mobile device replies to the EAP request message with an EAP response message having the second authentication value as well as a next handoff authentication information preferably including an “AT_NEXT_NOUNCE_MT” value. The next handoff authentication information similar to the initiate authentication information is provided for a potential handoff authentication. The AAA server 22 issues an EAP success message to the mobile device via the AP 212 after authenticating the second authentication value. It is noted that, conventionally, the next handoff authentication information is generated when the mobile device hands off the data communication from the AP 212 to another AP, resulting in excessive transmission time for authentication messages.

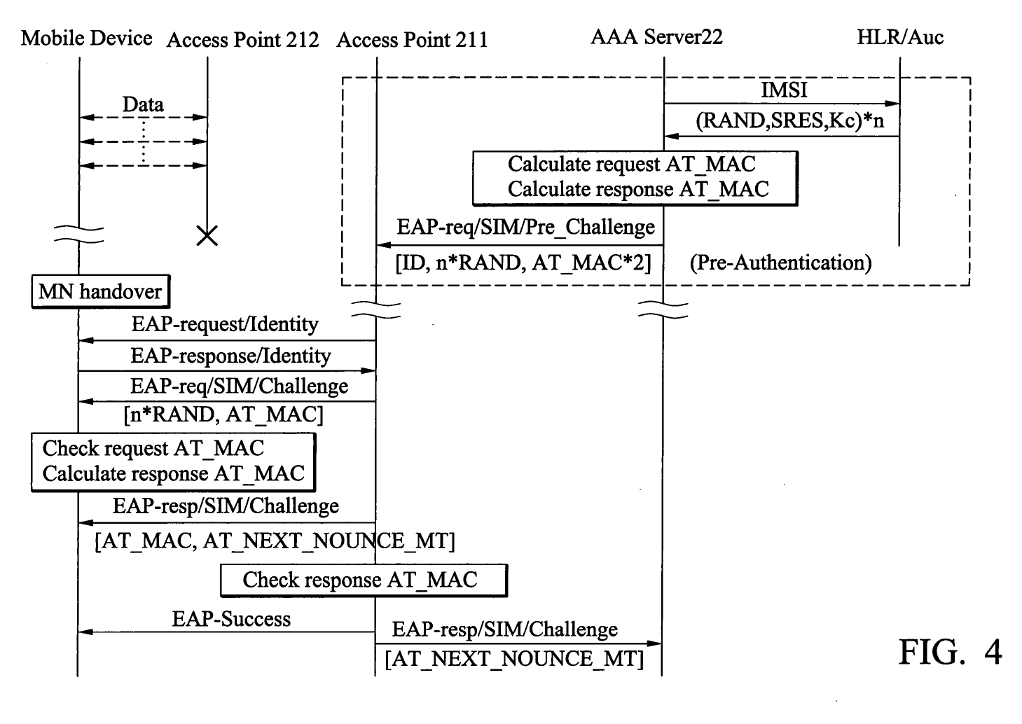

FIG. 4 is an exemplary communication sequence diagram of the data communication and handoff authentication phases according to the invention. In the data communication phase, the AAA server 22 asks the HLR/Auc to acquire new authentication seed information corresponding to the IMSI, preferably including at least one authentication triplet, individually comprising a random number (RAND), a signature response (SRES) value and a cipher key (Kc). Similar to the above phase, the AAA server 22 calculates a third authentication value, the third authentication value is provided to the mobile device for the AAA server authentication. The third authentication value preferably includes a third “AT_MAC” value calculated by the HMAC-SHA1-128 algorithm utilizing both the AT_NEXT_NOUCE_MT value and the Kc value as input parameters. The AAA server 22 additionally calculates a fourth authentication value, the fourth authentication value is provided to neighboring APs for a potential handoff authentication of the mobile device. The fourth authentication value preferably includes a fourth AT_MAC value, and the fourth AT_MAC value is preferably calculated as follows. The AAA server calculates the fourth AT_MAC value using the HMAC-SHA1-128 algorithm utilizing both the SRES value and the Kc value as input parameters. The AAA server 22 issues an EAP request message with the third authentication value, the fourth authentication value and at least one authentication seed value, such as a RAND value, (i.e., EAP-req/SIM/Pre_Challenge) to the neighboring APs, 211 and 213. The authentication seed value enables the mobile device to generate the fourth authentication value.

In the handoff authentication phase, the AP 211 issues an EAP request for the mobile device identity (i.e., EAP-request/Identity) when the mobile device hands off data communication from the AP 212 to the AP 211. The mobile device replies to the request message with an EAP response message preferably having the IMSI. The AP 211 issues a proprietary EAP request message with the authentication seed value and the third authentication value (i.e., EAP-request/SIM/Challenge) to the mobile device. After the received authentication value is successfully authenticated, the mobile device calculates a fifth authentication value. The fifth authentication value preferably includes a fifth AT_MAC value, and the fifth AT_MAC value is preferably calculated as follows. The mobile device calculates at least one SRES value using the A3 algorithm utilizing both the RAND value from the AP 211 and the Ki value as input parameters, at least one Kc value using the A8 algorithm utilizing both the RAND value and the Ki value as input parameters, and then calculates the fifth AT_MAC value using the HMAC-SHA1-128 algorithm utilizing both the resulting SRES value and the resulting Kc value as input parameters. The mobile device replies to the proprietary EAP request message with a proprietary EAP response message having the fifth authentication value as well as next handoff authentication information preferably including an AT_NEXT_NOUNCE_MT value to the AP 211. The newly generated AT_NEXT_NOUNCE_MT value is provided for a potential handoff authentication.

The AP 211 sends an EAP Success message to the mobile device and sends the next handoff authentication information to the AAA server 22 if the fifth authentication value from the mobile device corresponds to the fourth AT_MAC value from the AAA server 22. The remaining pre-authentication mechanisms may be deduced by analogy.

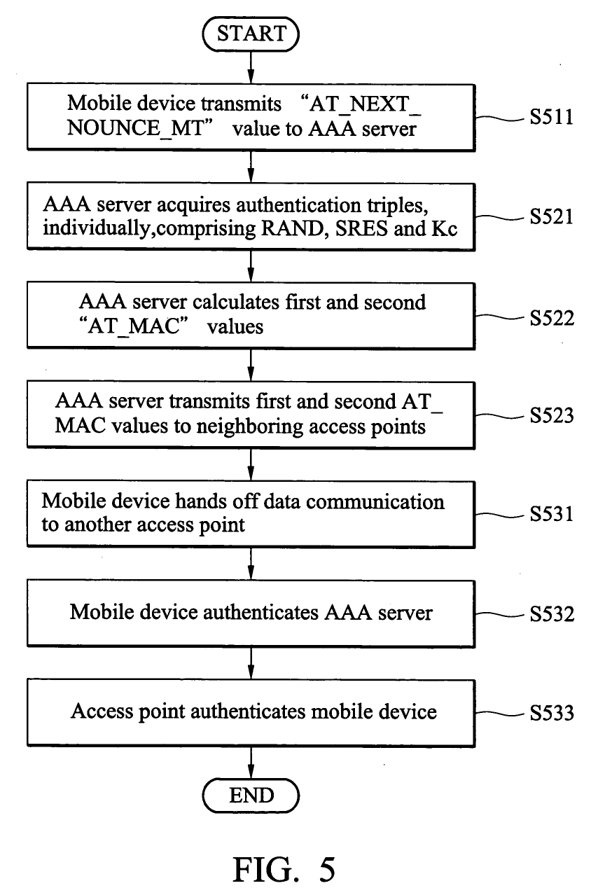

FIG. 5 is a flowchart showing a method of SIM based pre-authentication across WLANs according to the invention. Referring to the FIG. 2, the method is applied in a wireless environment having the APs, such as 211, 212 and 213, and the AAA server 22.

The process begins, in step S511, when the mobile device transmits an AT_NEXT_NOUNCE_MT value to the AAA server 22 during the initiate or handoff authentication phase. The AT_NEXT_NOUNCE_MT value is provided for a potential handoff authentication.

The process then proceeds to step S521 to S523 for handoff authentication for the data communication session between the mobile device and the AP 212. In step S521, the AAA server asks the HLR/Auc to acquire multiple authentication triplets corresponding to the mobile device, individually comprising a random number (RAND), a signature response (SRES) value and a cipher key (Kc). In step S522, the AAA server 22 calculates a first AT_MAC value using the HMAC-SHA1-128 algorithm utilizing the AT_NEXT_NOUCE_MT value and the multiple Kc values as input parameters, and the first AT_MAC value is provided to the mobile device for AAA server authentication. The AAA server 22 calculates a second AT_MAC value using the HMAC-SHA1-128 algorithm utilizing the SRES values and the Kc value as input parameters, and the second AT_MAC value is provided to the neighboring APs for the mobile device handoff authentication. In step S523, the AAA server 22 issues an EAP request message with the first AT_MAC value, the second AT_MAC value, and the RAND values (e.g., EAP-req/SIM/Pre_Challenge) to the neighboring APs, 211 and 213.

In step S531, the AP 211 issues an EAP request for the mobile device identity (i.e., EAP-request/Identity) when the mobile device hands off the data communication from the AP 212 to the AP 211. The mobile device replies to the request message with an EAP response message having the IMSI. The AP 211 issues a proprietary EAP request message with the RAND values and the first AT_MAC value (i.e., EAP-request/SIM/Challenge) to the mobile device. In step S532, the mobile device calculates multiple SRES values using the A3 algorithm utilizing the RAND values from the AP 211 and the Ki value as input parameters, multiple Kc values using the A8 algorithm utilizing the RAND values and the Ki value, and calculates another AT_MAC value using the HMAC-SHA1-128 algorithm utilizing the resulting SRES values and the resulting Kc values as input parameters after authenticating the received AT_MAC value. The mobile device replies to the proprietary EAP request message with a proprietary EAP response message having the calculated AT_MAC value as well as an AT_NEXT_NOUNCE_MT value to the AP 211. The AT_NEXT_NOUNCE_MT value is subsequently utilized to authenticate the next handoff authentication. In step S533, the AP 211 sends an EAP Success message to the mobile device and sends the received AT_NEXT_NOUCE_MT value to the AAA server 22 if the AT_MAC value from the mobile device corresponds to the second AT_MAC value from the AAA server 22. The remaining pre-authentication mechanisms may be deduced by analogy.

The system and method of this invention provide a SIM-based pre-authentication mechanism to perform complicated authentication procedures during association of a mobile device with an AP. When the mobile device hands off the data communication to another AP, that the pre-calculated authentication information, such as AT_MAC value, stored in the AP, enables reduction of the excessive time required for transmission of authentication messages.

Although the present invention has been described in its preferred embodiments, it is not intended to limit the invention to the precise embodiments disclosed herein. Those who are skilled in this technology can still make various alterations and modifications without departing from the scope and spirit of this invention. Therefore, the scope of the present invention shall be defined and protected by the following claims and their equivalents.

1. A system for pre-authentication in a wireless local area network (WLAN) environment, comprising:
a first access point, receiving next handoff authentication information from a mobile device during authentication of the mobile device with the first access point;
an authentication server, receiving the next handoff authentication information, acquiring an authentication seed value corresponding to the mobile device, and calculating a first authentication value using the authentication seed value during a data communication session between the mobile device and the first access point; and
a second access point, receiving the first authentication value and the authentication seed value during the data communication session between the mobile device and the first access point, receiving a connection request message and transmitting the authentication seed value to the mobile device when the mobile device hands off the data communication session from the first access point to the second access point, and authenticating the mobile device if a second authentication value from the mobile device corresponds to the first authentication value.

2. The system as claimed in claim 1 wherein the next handoff authentication information comprises an “AT_NEXT_NOUNCE_MT” value, the authentication seed value comprises at least one random number (RAND), and the first and second authentication values are calculated using an “HMAC-SHA1-128” algorithm.

3. The system as claimed in claim 1 wherein the mobile device, the first access point, the second access point and the authentication server communicate using an Extensible Authentication Protocol over LAN (EAPOL).

4. The system as claimed in claim 2 wherein the mobile device, the first access point, the second access point and the authentication server communicate using an Extensible Authentication Protocol over LAN (EAPOL).

5. The system as claimed in claim 1 wherein the authentication server calculates a third authentication value using the next handoff authentication information during the data communication session between the mobile device and the first access point, the second access point transmitting the third authentication value to the mobile device during the mobile device hands off the data communication session from the first access point to the second access point, and the mobile device issues the connection request message if the third authentication value is authenticated.

6. The system as claimed in claim 2 wherein the authentication server calculates a third authentication value using the next handoff authentication information during the data communication session between the mobile device and the first access point, the second access point transmitting the third authentication value to the mobile device during the mobile device hands off the data communication session from the first access point to the second access point, and the mobile device issues the connection request message if the third authentication value is authenticated.

7. The system as claimed in claim 6 wherein the third authentication value is calculated using an “HMAC-SHA1-128” algorithm.

8. The system as claimed in claim 3 wherein the authentication server calculates a third authentication value using the next handoff authentication information during the data communication session between the mobile device and the first access point, the second access point transmitting the third authentication value to the mobile device during the mobile device hands off the data communication session from the first access point to the second access point, and the mobile device issues the connection request message if the third authentication value is authenticated.

9. A method for pre-authentication utilized in a wireless local area network (WLAN) environment comprising a first access point, a second access point and an authentication server, performing the steps of: receiving next handoff authentication information from a mobile device during authentication of the mobile device with the first access point;
receiving the next handoff authentication information from the first access point with the authentication server;
acquiring an authentication seed value corresponding to the mobile device during a data communication session between the mobile device and the first access point with the authentication server;
calculating a first authentication value using the authentication seed value with the authentication server;
receiving the first authentication value and the authentication seed value during the data communication session between the mobile device and the first access point with the second access point;
receiving a connection request message and transmitting the authentication seed value to the mobile device when the mobile device hands off the data communication session from the first access point to the second access point with the second access point; and
authenticating the mobile device if a second authentication value from the mobile device corresponds to the first authentication value with the second access point.

10. The method as claimed in claim 9 wherein the next handoff authentication information comprises an “AT_NEXT_NOUNCE_MT” value, the authentication seed value comprises at least one random number (RAND), and the first and second authentication values are calculated using an “HMAC-SHA1-128” algorithm.

11. The method as claimed in claim 9 wherein the mobile device, the first access point, the second access point and the authentication server communicate using an Extensible Authentication Protocol over LAN (EAPOL).

12. The method as claimed in claim 10 wherein the mobile device, the first access point, the second access point and the authentication server communicate using an Extensible Authentication Protocol over LAN (EAPOL).

13. The method as claimed in claim 9 further comprises the steps of:
calculating a third authentication value using the next handoff authentication information during the data communication session between the mobile device and the first access point with the authentication server;
transmitting the third authentication value to the mobile device when the mobile device hands off the data communication session from the first access point to the second access point with the second access point; and
issuing the connection request message if the third authentication value is authenticated with the mobile device.

14. The method as claimed in claim 10 further comprises the steps of:
calculating a third authentication value using the next handoff authentication information during the data communication session between the mobile device and the first access point with the authentication server;
transmitting the third authentication value to the mobile device when the mobile device hands off the data communication session from the first access point to the second access point with the second access point; and
issuing the connection request message if the third authentication value is authenticated with the mobile device.

15. The method as claimed in claim 14 wherein the third authentication value is calculated using an “HMAC-SHA1-128” algorithm.

16. The method as claimed in claim 11 further comprises the steps of:
calculating a third authentication value using the next handoff authentication information during the data communication session between the mobile device and the first access point with the authentication server;
transmitting the third authentication value to the mobile device when the mobile device hands off the data communication session from the first access point to the second access point with the second access point; and
issuing the connection request message if the third authentication value is authenticated with the mobile device.
